(19) United States
(12) Patent Application Publication
(10) Pub. No.: US 2009/0038178 A1
(43) Pub. Date: Feb. 12, 2009

(54) CLOTHES DRYER

(76) Inventors: Seung-Phyo AHN, Changwon (KR); Sang-Ik LEE, Changwon (KR); Byeong-Jo RYOO, Changwon (KR); Sung-Ho SONG, Changwon (KR); Jeong-Yun KIM, Changwon (KR); Yang-Hwan KIM, Changwon (KR); Jae-Hyuk WEE, Changwon (KR); Dong-Hyun KIM, Changwon (KR); Yoon-Seob EOM, Changwon (KR); Yang-Ho KIM, Changwon (KR)

Correspondence Address: KED & ASSOCIATES, LLP, P.O. Box 221200, Chantilly, VA, 20153-1200, US

(21) Appl. No.: 12/183,199

(22) Filed: Jul. 31, 2008

(30) Foreign Application Priority Data
Aug. 6, 2007 (KR) 10-2007-0078736

(51) Int. Cl. F26B 21/08; D06F 58/02; F28F 1/10; F26B 21/00

(52) U.S. Cl. 34/557; 34/108; 34/72; 165/181

(57) ABSTRACT

A clothes drier comprises a dehumidifying unit configured to dehumidify air exhausted from the drum, and to control an amount of water to be supplied thereto according to a drying level of clothes. As an amount of water supplied to the dehumidifying unit is controlled according to a drying level of clothes, a water consumption amount is reduced.

### RELATED APPLICATION

The present invention relates to subject matter contained in priority Korean Application 10-2007-0078736, filed Aug. 6, 2007, which is herein expressly incorporated by reference in its entirety.

### BACKGROUND OF THE INVENTION

1. Field of the Invention

The present invention relates to a clothes drier, and more particularly, to a clothes drier having a dehumidifying unit configured to dehumidify humid air exhausted when clothes are completely dried.

2. Description of the Background Art

Generally, a clothes drier serves to dry clothes by blowing hot air into a drum and thereby absorbing moisture inside the clothes. The clothes drier may be largely classified into an exhausting type, a condensing type, and a ductless type according to a processing method for air occurring when clothes are dried.

The condensing type clothes drier and the ductless type clothes drier include a dehumidifying unit having a heat exchanger, so that moisture inside humid air after clothes are dried may be removed. A large amount of water is supplied to the heat exchanger of the dehumidifying unit so that moisture inside air passing through the heat exchanger can be removed in a water cooled manner. As water supplied to the heat exchanger performs heat exchange with air passing through the heat exchanger, moisture inside the air is removed. This type of heat exchanger is called as a water-cooled heat exchanger.

In the case that clothes has a high drying level change by undergoing an active drying process, after the clothes are dried, a large amount of moisture is included in air passing through the heat exchanger. Accordingly, a large amount of water is required to dehumidify the air.

However, in the case that clothes has a small drying level change by undergoing a process for initially drying the clothes (increasing a temperature of the clothes), and a process for completing to dry the clothes, a small amount of moisture is included in air passing through the heat exchanger. Accordingly, a large amount of water is not required to dehumidify the air.

In spite of the principle, the conventional condensing type clothes drier and the ductless type clothes drier having a water-cooled type heat exchanger, a large amount of water is always supplied to the heat exchanger until the operation is completed, regardless of a drying level of clothes. Accordingly, a water consumption amount is increased.

### SUMMARY OF THE INVENTION

Therefore, it is an object of the present invention to provide a clothes drier capable of reducing consumption amount of water supplied to a dehumidifying unit.

It is another object of the present invention to provide a clothes drier capable of controlling water amount supplied to a dehumidifying unit according to a drying level of clothes.

To achieve these and other advantages and in accordance with the purpose of the present invention, as embodied and broadly described herein, there is provided a clothes drier, comprising: a body; a drum rotatably installed at the body; a hot air supply unit configured to supply hot air into the drum; and a dehumidifying unit configured to dehumidify air exhausted from the drum, and to control an amount of water to be supplied thereto according to a drying level of clothes. As an amount of water supplied to the dehumidifying unit is controlled according to a drying level of clothes, thereby reducing a water consumption amount.

The dehumidifying unit comprises a heat exchanger configured to pass air exhausted from the drum; a variable valve configured to vary an amount of water flowing inside the heat exchanger; a sensing unit configured to detect a drying level of clothes inside the drum; and a controller configured to control the variable valve by calculating a drying level of clothes by receiving a signal from the sensing unit.

Preferably, the heat exchanger includes a plurality of fins and tubes passing through the fins, and the variable valve is installed on the tube.

Preferably, the variable valve is an analogue value configured to consecutively control an amount of water, or a digital valve configured to control an amount of water step by step. Preferably, the variable valve includes a first channel through which a small amount of water flows; a first valve configured to open and close the first channel; a second channel through which a large amount of water flows; and a second valve configured to open and close the second channel.

Preferably, the sensing unit includes a temperature sensor configured to detect a temperature of air passing through the heat exchanger; and a humidity sensor configured to detect humidity of air passing through the heat exchanger. Preferably, the heat exchanger includes a first heat exchanger; and a second heat exchanger arranged to introduce air passing through the first heat exchanger thereinto. Preferably, the temperature and the humidity sensor are installed at an inlet of the first heat exchanger and an outlet of the second heat exchanger, respectively.

Preferably, the sensing unit is implemented as a temperature sensor configured to detect a temperature of air exhausted from the drum, or as an electrode sensor contacting clothes inside the drum.

The drying level changes as clothes undergo a first step for initially heating clothes, a second step for actively starting to dry clothes, a third step for completing to dry clothes, and a fourth step for cooling clothes. Preferably, in the first and third steps, the first valve is opened, but the second valve is closed. In the second step, the first valve is closed, but the second valve is opened. In the fourth step, the first and second valves are closed.

To achieve these and other advantages and in accordance with the purpose of the present invention, as embodied and broadly described herein, there is also provided a clothes drier, comprising: a body; a drum rotatably installed at the body; a hot air supply unit configured to supply hot air into the drum; and a dehumidifying unit configured to dehumidify air exhausted from the drum, and to control an amount of water to be supplied thereto according to a drying level of clothes. The drying level changes as clothes undergo a first step for initially heating clothes, a second step for actively starting to dry clothes, a third step for completing to dry clothes, and a fourth step for cooling clothes.

Preferably, the dehumidifying unit includes a heat exchanger; a variable valve configured to vary an amount of water flowing inside the heat exchanger; and a controller configured to control the variable valve according to change of the drying level.

Preferably, the controller controls the variable valve so that a small amount of water can flow in the first and third steps, a large amount of water can flow in the second step, and water flowing is shielded in the fourth step.

To achieve these and other advantages and in accordance with the purpose of the present invention, as embodied and broadly described herein, there is still also provided a clothes drier, comprising: a water-cooled type heat exchanger; a temperature sensor configured to detect a temperature of air passing through the water-cooled type heat exchanger; a humidity sensor configured to detect humidity of air passing through the water-cooled type heat exchanger; and a controller configured to control an amount of water supplied to the water-cooled type heat exchanger according to the temperature and the humidity detected by the temperature sensor and the humidity sensor, respectively.

The temperature and the humidity changes are indicated as clothes undergo a first step for initially heating clothes, a second step for actively starting to dry clothes, a third step for completing to dry clothes, and a fourth step for cooling clothes. Preferably, a drying level of clothes is low in the first and third steps, a drying level of clothes is high in the second step, and a drying level of clothes is the lowest in the fourth step.

Preferably, the controller controls so that a small amount of water can be supplied to the water-cooled type heat exchanger in the first and third steps, whereas a large amount of water can be supplied to the water-cooled type heat exchanger in the second step. The controller also controls so that no water can be supplied to the water-cooled type heat exchanger in the fourth step.

Preferably, the clothes drier is a condensing type clothes drier, or a ductless type clothes drier.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a clothes drier according to a first embodiment of the present invention;

FIG. 2 is a planar view of the clothes drier of FIG. 1;

FIG. 3 is an extracted view of a dehumidifying unit of FIG. 2;

FIG. 4 is a block diagram showing an operational relation among a sensing unit, a controller, a variable valve, and a heat exchanger of FIG. 2;

FIG. 5 is a view showing a state that a first channel of the variable valve of FIG. 4 is opened, but a second channel thereof is closed;

FIG. 6 is a view showing a state that the first channel of the variable valve of FIG. 4 is closed, but the second channel thereof is opened;

FIG. 7 is a view showing a state that the first and second channels of the variable valve of FIG. 4 are closed;

FIG. 8 is a table showing a state that first and second valves of the variable valve of FIG. 4 are turned ON/OFF according to a drying level of clothes;

FIG. 9 is a graph showing a voltage change indicated by an electrode sensor contacting clothes inside a drum of FIG. 1 according to drying time;

FIG. 10 is a graph showing a temperature change indicated by a temperature sensor according to drying time, the temperatures sensor configured to detect a temperature of air exhausted from a drum of FIG. 2; and

FIG. 11 is a graph showing temperature and humidity changes indicated by a temperature sensor and a humidity sensor, each configured to detect a temperature and humidity of air passing through a heat exchanger of FIG. 3, according to drying time.

### DETAILED DESCRIPTION OF THE INVENTION

Reference will now be made in detail to the preferred embodiments of the present invention, examples of which are illustrated in the accompanying drawings.

Hereinafter, a clothes drier according to a first embodiment of the present invention will be explained in more detail.

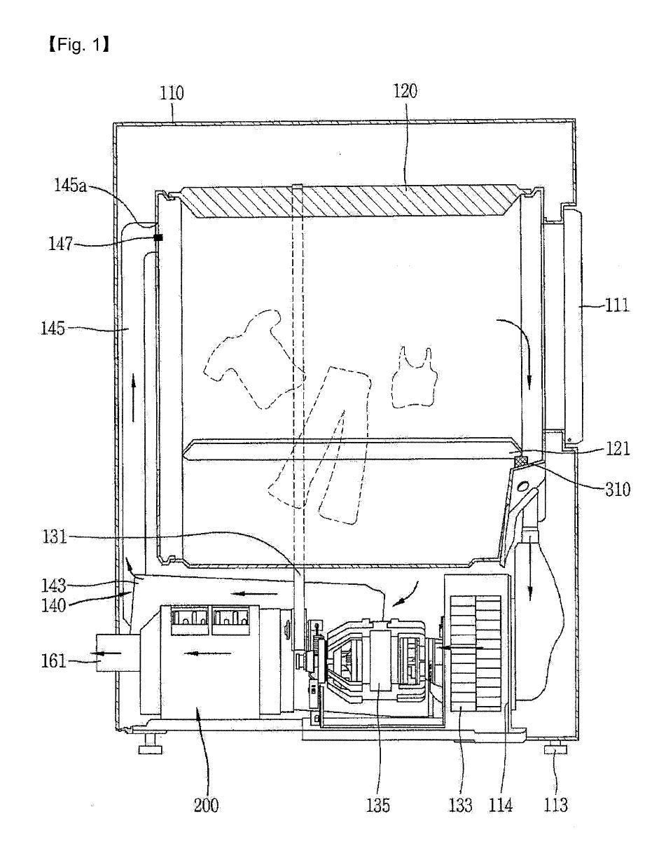

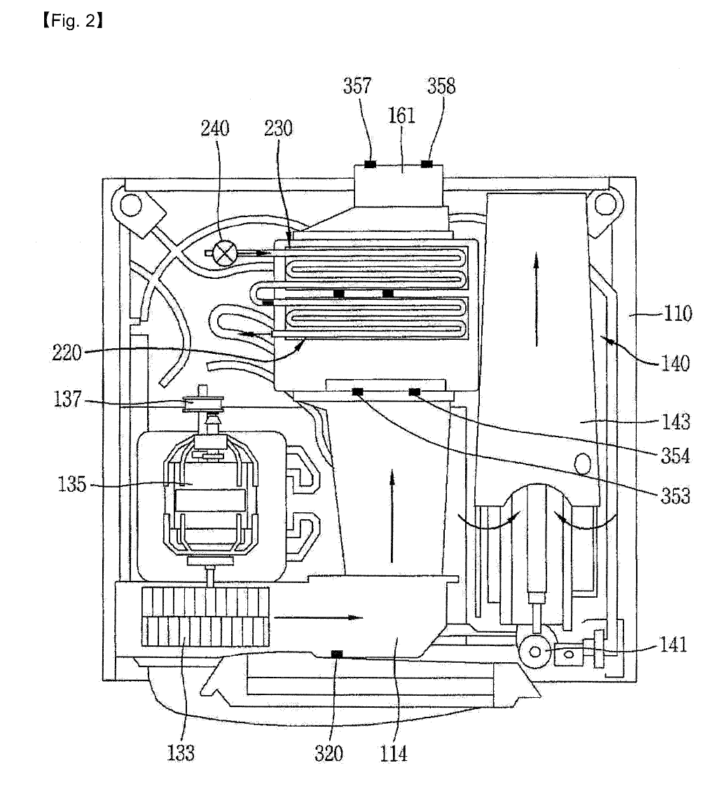

FIG. 1 is a schematic view of a clothes drier according to a first embodiment of the present invention, and FIG. 2 is a planar view of the clothes drier of FIG. 1. The arrow indicates air flow.

Referring to FIGS. 1 and 2, the clothes drier according to a first embodiment of the present invention comprises a body 110; a drum 120 rotatably installed at the body 110; a hot air supply unit 140 configured to supply hot air into the drum 120; and a dehumidifying unit 200 configured to dehumidify air exhausted from the drum 120, and to control an amount of water to be supplied thereto according to a drying level of clothes. As an amount of water supplied to the dehumidifying unit 200 is controlled according to a drying level of clothes, thereby reducing a water consumption amount.

A door 111 through which clothes are introduced into the drum 120 is installed on a front surface of the body 110, and a foot 113 configured to support the body 110 is installed below the body 110. Inside the body 110, installed are a belt 131 configured to rotate the drum 120, a fan 133 disposed inside a circulation duct 114 that provides a blowing force by air inside the clothes, and a motor 135 configured to provide a driving force to the belt 131 and the fan 133. A pulley 137 configured to lock the belt 131 is installed on a rotation shaft of the motor 135. Here, the motor 135 may be configured in plurality in number so that a driving force can be provided to the belt 131 and the fan 133, respectively.

At the circulation duct 114, installed is a filter (not shown) configured to filter lint such as nap and seam included in high temperature and high humid air exhausted from the drum 120.

The drum 120 is a box having an inner space to which an object to be dried, such as clothes, is introduced, and is provided with a plurality of lifters 121 therein configured to lift clothes. Hereinafter, an object to be dried will be called as clothes.

The hot air supply unit 140 includes a gas valve 141 configured to supply gas and shield gas supply, a gas combustor 143 configured to generate hot air by mixing gas exhausted from the gas valve 141 with external air and then by igniting the mixed air, a hot air supply duct 145 configured to connect the gas combustor 143 and the drum 120 to each other so that the generated hot air can be supplied to the drum 120, and a hot air temperature sensor 147 configured to detect a temperature of hot air introduced into the drum 120.

At the hot air supply unit 140, may be installed a flame rod extending from an edge of flame so as to detect a flame current and thus to indirectly judge an occurrence amount of carbon monoxide (CO) through a value of the flame current.

Based on a flame current measured by the flame rod, a controller (not shown) judges an occurrence amount of carbon monoxide (CO). Here, if the occurrence amount of carbon monoxide is increased enough to be harmful to a human body, gas supply is stopped and an alarm sound rings.

The gas combustor 143 is connected to the gas valve 141, thereby mixing gas exhausted from the gas valve 141 with external air and combusting the mixed gas. Then, generated heated is used to heat air.

Hot air generated by heating air is provided to the drum 120 through the hot air supply duct 145.

The hot air temperature sensor 147 is installed at a connection part 145a between the hot air supply duct 145 and the drum 120. The hot air temperature sensor 147 may be installed in plurality in number, and may be installed in the hot air supply duct 145.

If a temperature of air introduced into the drum 120 and detected by the hot air temperature sensor 147 exceeds a reference temperature (a temperature to prevent damage of clothes or to prevent fire occurrence), clothes damage occurs in case of the followings. A first case is that a volume of air flowing inside the clothes drier is decreased, e.g., air flow is prevented as lint is inserted into the filter. A second case is that air flow is not smooth due to too large amount of clothes inside the drum. In the second case, a duct connected to outside is blocked thus to decrease an air volume inside the clothes drier.

To prevent the above cases, the hot air supply unit 140 controls an amount of gas supplied to the gas combustor 143 by controlling the gas valve 141 according to an air volume. More concretely, when an air volume is decreased to cause a temperature detected by the hot air temperature sensor 147 to exceed a reference temperature, the gas valve 141 is partially or completely closed. Accordingly, an amount of gas supplied to the gas combustor 143 is decreased, or gas is prevented from being introduced into the gas combustor 143. Preferably, the gas valve 141 is implemented as a solenoid valve so as to sensitively adjust a gas injection amount.

Consequently, air temperature can be lowered by reducing an amount of heat supplied to air introduced into the drum 120 without frequently stopping gas combustion. Accordingly, clothes are prevented from being damaged, and the clothes drier has an enhanced stability.

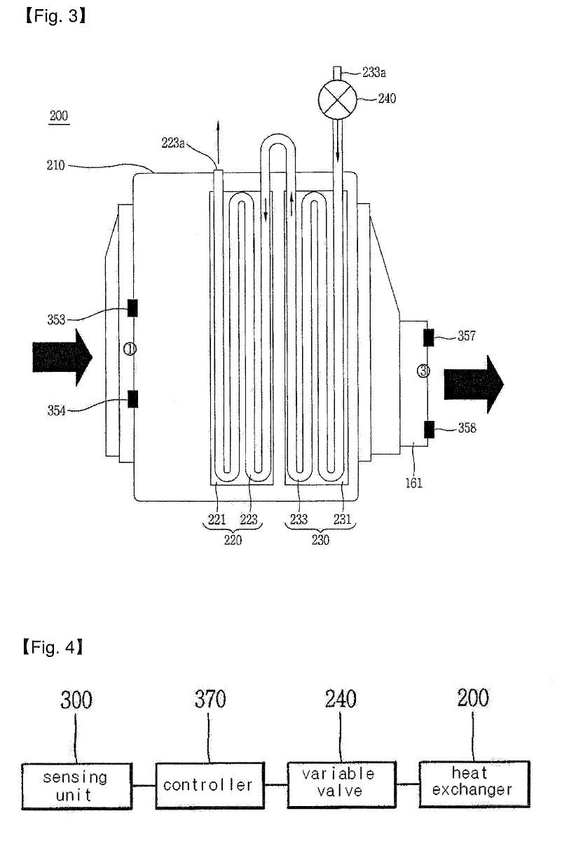

FIG. 3 is an extracted view of a dehumidifying unit of FIG. 2, and FIG. 4 is a block diagram showing an operational relation among a sensing unit, a controller, a variable valve, and a heat exchanger of FIG. 2. In FIG. 3, thick arrow indicates flow or air passing through the dehumidifying unit, and thin arrow indicates flow of water passing through tubes.

Referring to FIGS. 3 and 4, the dehumidifying unit 200 includes a case 210 having a receiving space, one or more heat exchangers 220, 230 received in the case 210, a variable valve 240 configured to vary an amount of water flowing in the heat exchanger, a sensing unit 300 configured to detect a drying level of clothes inside the drum; and a controller 370 configured to control the variable valve 240 by calculating a drying level of the clothes by receiving a signal from the sensing unit 300.

The heat exchanger includes a first heat exchanger 220 and a second heat exchanger 230. The heat exchanger may be implemented as one heat exchanger, or as three or more heat exchangers.

The first heat exchanger 220 includes fins 221 and tubes 223. And, the first heat exchanger 220 condenses high temperature and high humid air exhausted from the drum 120 by using water in a heat exchange manner between the air and the water, thereby making the air be in a dried state. The first heat exchanger 220 is installed at the left side of the case 210 so as to be disposed at an outlet of the circulation duct 114 connected to the drum 120.

The fins 221 are formed as a plurality of metallic thin plates having an excellent conductivity are laminated to each other with a minute gap therebetween so as to vertically contact and pass high temperature and high humid air.

The tube 223 has water of a low temperature (22° C.) circulating therein, and penetrates the fins 221 in a zigzag manner.

Similar to the first heat exchanger 220, the second heat exchanger 230 includes fins 231 and tubes 233. And, the second heat exchanger 230 again condenses dehumidified air passing through the first heat exchanger 220 by using water of a low temperature in a heat exchange manner between the air and the water, thereby making the air be in a dried state.

The second heat exchanger 230 is installed at the right side of the case 210 so as to be disposed at an inlet of an exhaustion duct 161 of FIG. 1.

The fins 231 are formed as a plurality of metallic thin plates having an excellent conductivity are laminated to each other with a minute gap therebetween so as to vertically contact and pass high temperature and high humid air.

The tube 233 has water of a low temperature (22° C.) circulating therein, and penetrates the fins 231 in a zigzag manner.

The tube 223 of the first heat exchanger 220 is connected to the tube 233 of the second heat exchanger 230 at an intermediate point between the first heat exchanger 220 and the second heat exchanger 230.

Water supplied to an inlet 233a of the tube 233 of the second heat exchanger 230 passes through the second heat exchanger 230 and the first heat exchanger 220. Then, the water is discharged out through an outlet 223a of the tube 223 of the first heat exchanger 220. To this end, the inlet 233a of the tube 233 of the second heat exchanger 230 is connected to an external water supply source (not shown).

More concretely, once water is introduced into the inlet 233a of the tube 233 of the second heat exchanger 230, the water cools the fins 231 of the second heat exchanger 230 and the fins 221 of the first heat exchanger 220 via the variable valve 240 and the tubes 233, 223. Then, the water is discharge out through the outlet 223a of the tube 223 of the first heat exchanger 220.

The variable valve 240 is installed at the inlet 233a of the tube 233 of the second heat exchanger 230. The variable valve 240 controls an amount of water supplied to the inlet 233a by varying an opening under control of the controller 370. To this end, the variable valve 240 is implemented as an analogue value configured to consecutively control an amount of water, or a digital valve configured to control an amount of water step by step. In the preferred embodiment, the variable valve 240 is configured as follows.

For more precise control, the variable valve 240 may be implemented in plurality in number.

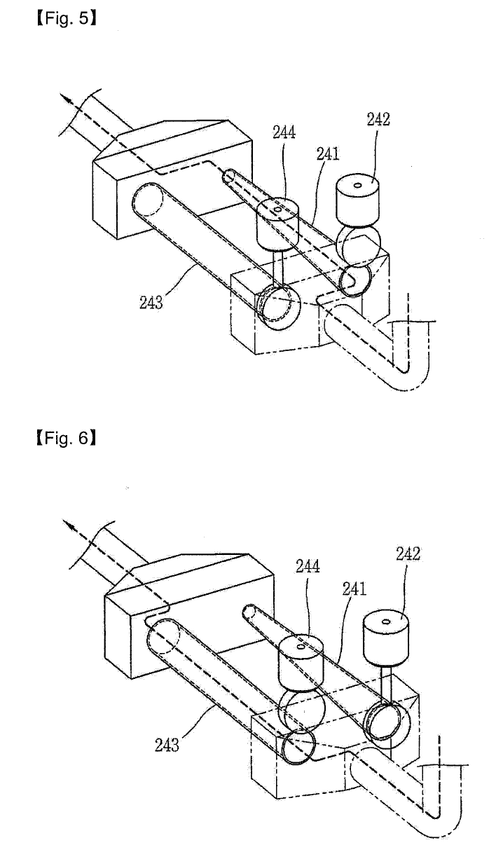

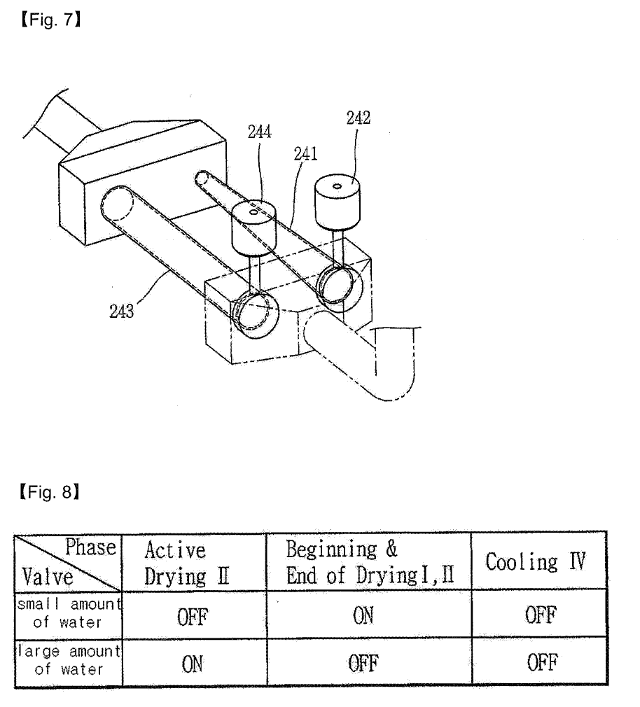

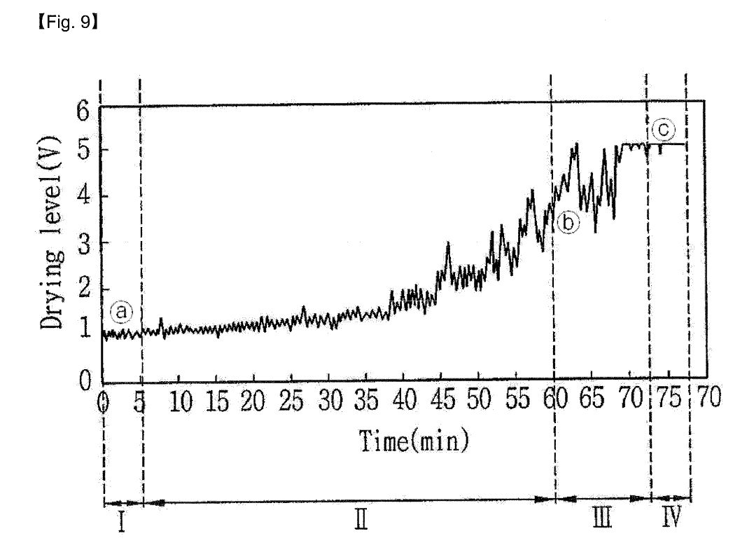

FIG. 5 is a view showing a state that a first channel of the variable valve of FIG. 4 is opened, but a second channel thereof is closed, FIG. 6 is a view showing a state that the first channel of the variable valve of FIG. 4 is closed, but the second channel thereof is opened, and FIG. 7 is a view showing a state that the first and second channels of the variable valve of FIG. 4 are closed. Referring to FIGS. 5 to 7, the variable valve 240 includes a first channel 241 through which a small amount of water (60˜80 kg/hr) flows; a first valve 242 configured to open and close the first channel 241; a second channel 243 through which a large amount of water (140˜160 kg/hr) flows; and a second valve 244 configured to open and close the second channel 243. Preferably, the first valve 242 and the second valve 244 are implemented as solenoid valves configured to block the first channel 241 and the second channel 243. Here, the first channel 241 has a conical shape having a cut-out outlet. That is, the outlet of the first channel 241 through which water is discharged out has a diameter smaller than that of the cylindrical second channel 243. Accordingly, a small amount of water is discharged from the outlet of the first channel 241.

Referring to FIG. 1, the sensing unit 300 is implemented as an electrode sensor 310 contacting clothes inside the drum 120. Once moisture-contained clothes contacts the electrode sensor 310, the electrode sensor 310 senses a drying level of the clothes by using an impedance difference between its two ends. Then, the electrode sensor 310 outputs the drying level as a voltage signal.

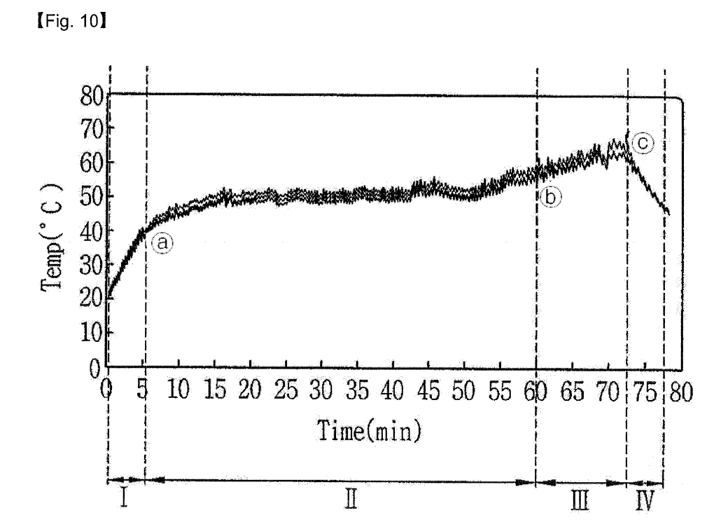

FIG. 9 is a graph showing a voltage change indicated by an electrode sensor contacting clothes inside a drum of FIG. 1 according to drying time.

Referring to FIG. 9, the electrode sensor 310 indicates a voltage change as clothes undergo a first step (I) for initially heating clothes, a second step (II) having a time point (\textcircled{a}) for actively starting to dry clothes, a third step (III) having a time point (\textcircled{b}) for completing to dry clothes, and a fourth step (IV) having a time point (\textcircled{c}) for cooling clothes.

At each step where different voltage gradients are shown according to drying time, the controller 370 (refer to FIG. 4) controls an amount of water supplied to the heat exchanger 220, 230 (refer to FIG. 1) by controlling the variable valve 240. That is, under the control of the controller 370, a large amount of water is supplied to the heat exchanger 200 in the second step (II), whereas a small amount of water is supplied to the heat exchanger in the first and third steps (I, III). And, water supply to the heat exchanger 200 is blocked in the fourth step (IV).

More concretely, referring to FIGS. 5 and 9, in the first and third steps (I, III) where a drying level change of clothes is low, the first channel 241 is opened by the first valve 242, and the second channel 243 is closed by the second valve 244. Accordingly, a small amount of water is supplied to the heat exchanger 200 (refer to FIG. 1) along dotted arrows.

On the other hand, referring to FIGS. 6 and 9, in the second step (II) where a drying level change of clothes is high, the first channel 241 is closed by the first valve 242, and the second channel 243 is opened by the second valve 244. Accordingly, a large amount of water is supplied to the heat exchanger 200 (refer to FIG. 1) along dotted arrows.

Referring to FIGS. 7 and 9, in the fourth step (IV) where the changing rate of a drying level change of clothes is the lowest, the first channel 241 is closed by the first valve 242, and the second channel 243 is closed by the second valve 244. Accordingly, water is not supplied to the heat exchanger 200 (refer to FIG. 1) any longer.

As an amount of water supplied to the heat exchanger 200 (refer to FIG. 1) is controlled according to a drying level of clothes, a water consumption amount is reduced.

Referring to FIG. 2, the sensing unit 300 may include a temperature sensor 320 configured to detect a temperature of air exhausted from the drum 120. The temperature sensor 320 is installed in the circulation duct 114, and more concretely, is disposed on a rear end of the fan 133, thereby detecting a temperature of air passing through the fan 133. The temperatures sensor 320 may be disposed on a front end of the fan 133, thereby detecting a temperature of air before passing through the fan 133.

FIG. 10 is a graph showing a temperature change indicated by a temperature sensor according to drying time, the temperatures sensor configured to detect a temperature of air exhausted from the drum of FIG. 2.

Referring to FIG. 10, the temperature sensor 320 indicates a temperature change as clothes undergo a first step (I) for initially heating clothes, a second step (II) having a time point (\textcircled{a}) for actively starting to dry clothes, a third step (III) having a time point (\textcircled{b}) for completing to dry clothes, and a fourth step (IV) having a time point (\textcircled{c}) for cooling clothes.

At each step where different temperature gradients are shown according to drying time, the controller 370 (refer to FIG. 4) controls an amount of water supplied to the heat exchanger 200 (refer to FIG. 1) by controlling the variable valve 240. That is, under the control of the controller 370, a large amount of water is supplied to the heat exchanger 200 in the second step (II), whereas a small amount of water is supplied to the heat exchanger in the first and third steps (I, III). And, water supply to the heat exchanger 200 is blocked in the fourth step (IV).

More concretely, referring to FIGS. 5 and 10, in the first and third steps (I, III) where a drying level of clothes is low, the first channel 241 is opened by the first valve 242, and the second channel 243 is closed by the second valve 244. Accordingly, a small amount of water is supplied to the heat exchanger 200 (refer to FIG. 1) along dotted arrows.

On the other hand, referring to FIGS. 6 and 10, in the second step (II) where a drying level of clothes is high, the first channel 241 is closed by the first valve 242, and the second channel 243 is opened by the second valve 244. Accordingly, a large amount of water is supplied to the heat exchanger 200 (refer to FIG. 1) along dotted arrows.

Referring to FIGS. 7 and 10, in the fourth step (IV) where a drying level of clothes is the highest, the first channel 241 is closed by the first valve 242, and the second channel 243 is closed by the second valve 244. Accordingly, water is not supplied to the heat exchanger 200 (refer to FIG. 1) any longer.

As an amount of water supplied to the heat exchanger 200 (refer to FIG. 1) is controlled according to a drying level of clothes, a water consumption amount is reduced.

Referring to FIG. 3, the sensing unit 300 may be differently configured as temperatures sensors 353, 357, and humidity sensors 354, 358. The temperature sensors 353, 357 are respectively installed at an inlet \textcircled{1} of the first heat exchanger 220, and an outlet \textcircled{3} of the second heat exchanger 230, thereby detecting a temperature of air passing through the first and second heat exchangers 220, 230. The humidity sensors 354, 358 serves to detect humidity of air passing through the first and second heat exchangers 220, 230.

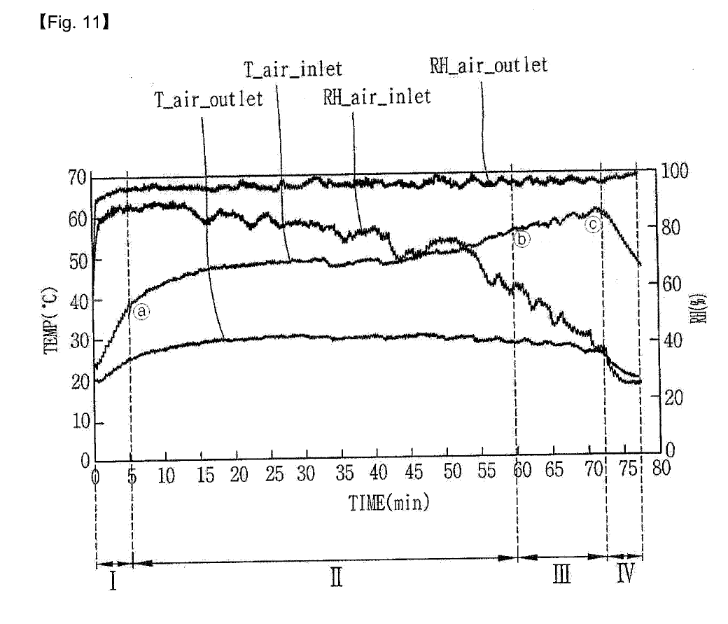

FIG. 11 is a graph showing temperature and humidity changes indicated by a temperature sensor and a humidity sensor, each configured to detect a temperature and humidity of air passing through the heat exchanger of FIG. 3, according to drying time.

Referring to FIG. 11, the temperature sensors 353, 357 and the humidity sensors 354, 358 indicate temperature and humidity changes as clothes undergo a first step (I) for initially heating clothes, a second step (II) having a time point (\textcircled{a}) for actively starting to dry clothes, a third step (III) having a time point (\textcircled{b}) for completing to dry clothes, and a fourth step (IV) having a time point (\textcircled{c}) for cooling clothes.

Here, RH_air_outlet indicates a relative humidity of air detected at the outlet \textcircled{3} by the humidity sensor 358, and RH_air_inlet indicates a relative humidity of air detected at the inlet \textcircled{1} by the humidity sensor 354. T_air_inlet indicates a temperature of air detected at the inlet \textcircled{1}by the temperature sensor 353, and T_air_outlet indicates a temperature of air detected at the outlet \textcircled{3} by the temperature sensor 357.

At each step where different temperature and humidity gradients are shown according to drying time, the controller 370 (refer to FIG. 4) controls an amount of water supplied to the heat exchanger 200 (refer to FIG. 1) by controlling the variable valve 240.

More concretely, referring to FIGS. 5 and 11, in the first and third steps (I, III) where a drying level change of clothes is low, the first channel 241 is opened by the first valve 242, and the second channel 243 is closed by the second valve 244. Accordingly, a small amount of water is supplied to the heat exchanger 200 (refer to FIG. 1) along dotted arrows.

On the other hand, referring to FIGS. 6 and 11, in the second step (II) where a drying level change of clothes is high, the first channel 241 is closed by the first valve 242, and the second channel 243 is opened by the second valve 244. Accordingly, a large amount of water is supplied to the heat exchanger 200 (refer to FIG. 1) along dotted arrows.

Referring to FIGS. 7 and 11, in the fourth step (IV) where a drying level of clothes is the highest, the first channel 241 is closed by the first valve 242, and the second channel 243 is closed by the second valve 244. Accordingly, water is not supplied to the heat exchanger 200 (refer to FIG. 1) any longer.

As an amount of water supplied to the heat exchanger 200 (refer to FIG. 1) is controlled according to a drying level of clothes, a water consumption amount is reduced.

As aforementioned, the clothes drier according to a first embodiment of the present invention includes the dehumidifying unit configured to dehumidify air exhausted from the drum, and to control an amount of water supplied thereto according to a drying level of clothes. As an amount of water supplied to the dehumidifying unit is controlled according to a drying level of clothes, a water consumption amount is reduced.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes drier, comprising:
a body;
a drum rotatably installed at the body;
a hot air supply unit configured to supply hot air into the drum; and
a dehumidifying unit configured to dehumidify air exhausted from the drum, and to control an amount of water to be supplied thereto according to a drying level of clothes.

2. The clothes drier of claim 1, wherein the dehumidifying unit comprises:
a heat exchanger configured to pass air exhausted from the drum;
a variable valve configured to vary an amount of water flowing inside the heat exchanger;
a sensing unit configured to detect a drying level of clothes inside the drum; and
a controller configured to control the variable valve by calculating a drying level of clothes by receiving a signal from the sensing unit.

3. The clothes drier of claim 2, wherein the heat exchanger is provided with a plurality of fins and tubes passing through the fins, and the variable valve is installed on the tube.

4. The clothes drier of claim 2, wherein the variable valve is an analogue value configured to consecutively control an amount of water.

5. The clothes drier of claim 2, wherein the variable valve is a digital valve configured to control an amount of water step by step.

6. The clothes drier of claim 2, wherein the variable valve comprises:
a first channel through which a small amount of water flows;
a first valve configured to open and close the first channel;
a second channel through which a large amount of water flows; and
a second valve configured to open and close the second channel.

7. The clothes drier of claim 6, wherein the drying level changes as the clothes undergo a first step for initially heating clothes, a second step for actively starting to dry clothes, a third step for completing to dry clothes, and a fourth step for cooling clothes,
wherein, in the first and third steps, the first valve is opened but the second valve is closed,
wherein, in the second step, the first valve is closed but the second valve is opened, and
wherein, in the fourth step, the first and second valves are closed.

8. The clothes drier of claim 2, wherein the sensing unit comprises:
a temperature sensor configured to detect a temperature of air passing through the heat exchanger; and
a humidity sensor configured to detect humidity of air passing through the heat exchanger.

9. The clothes drier of claim 8, wherein the temperature sensor and the humidity sensor are provided at an inlet and an outlet of the heat exchanger in one pair, respectively.

10. The clothes drier of claim 9, wherein the heat exchanger comprises:
a first heat exchanger; and
a second heat exchanger arranged to introduce air passing through the first heat exchanger thereinto, and
wherein the temperature sensor and the humidity sensor are provided at an inlet and an outlet of the heat exchanger in one pair, respectively.

11. The clothes drier of claim 2, wherein the sensing unit is implemented as a temperature sensor configured to detect a temperature of air exhausted from the drum.

12. The clothes drier of claim 2, wherein the sensing unit is implemented as an electrode sensor contacting clothes inside the drum.

13. A clothes drier, comprising:
a body;
a drum rotatably installed at the body;
a hot air supply unit configured to supply hot air into the drum; and
a dehumidifying unit configured to dehumidify air exhausted from the drum, and to control an amount of water to be supplied thereto according to a drying level of clothes, and
wherein the drying level changes as the clothes undergo a first step for initially heating clothes, a second step for actively starting to dry clothes, a third step for completing to dry clothes, and a fourth step for cooling clothes.

14. A clothes drier of claim 13, wherein the dehumidifying unit comprises:
a heat exchanger;
a variable valve configured to vary an amount of water flowing inside the heat exchanger; and
a controller configured to control the variable valve according to change of the drying level.

15. The clothes drier of claim 14, wherein the controller controls the variable valve so that a small amount of water can flow in the first and third steps, a large amount of water can flow in the second step, and water flow is blocked in the fourth step.

16. A clothes drier, comprising:
a water-cooled type heat exchanger;
a temperature sensor configured to detect a temperature of air passing through the water-cooled type heat exchanger;
a humidity sensor configured to detect humidity of air passing through the water-cooled type heat exchanger; and
a controller configured to control an amount of water supplied to the water-cooled type heat exchanger according to the temperature and the humidity detected by the temperature sensor and the humidity sensor, respectively.

17. The clothes drier of claim 16, wherein the temperature and the humidity change as clothes undergo a first step for initially heating cloths, a second step for actively starting to dry clothes, a third step for completing to dry clothes, and a fourth step for cooling clothes.

18. The clothes drier of claim 17, wherein a drying level change of the clothes is low in the first and third steps, a drying level change of the clothes is high in the second step, and a drying level change of the clothes is the lowest in the fourth step.

19. The clothes drier of claim 17, wherein the controller controls so that a small amount of water can be supplied to the water-cooled type heat exchanger in the first and third steps, so that a large amount of water can be supplied to the water-cooled type heat exchanger in the second step, and so that no water can be supplied to the water-cooled type heat exchanger in the fourth step.

20. The clothes drier of claim 16, wherein the clothes drier is a condensing type clothes drier, or a ductless type clothes drier.
